(19) United States
(12) Patent Application Publication
(10) Pub. No.: US 2013/0198244 A1
(43) Pub. Date: Aug. 1, 2013

(54) SYSTEMS AND METHODS FOR MONITORING DOCUMENT TRANSMISSION

(71) Applicants: KEVIN ALBRECHT, Lenexa, KS (US); Michael Todd Wessel, Lenexa, KS (US); Mark L. Guthrie, Washington, DC (US)

(72) Inventors: KEVIN ALBRECHT, Lenexa, KS (US); Michael Todd Wessel, Lenexa, KS (US); Mark L. Guthrie, Washington, DC (US)

(21) Appl. No.: 13/560,195

(22) Filed: Jul. 27, 2012

Related U.S. Application Data
(60) Provisional application No. 61/513,064, filed on Jul. 29, 2011.

(51) Int. Cl. G06F 17/30

(52) U.S. Cl. CPC G06F 17/30091
USPC 707/812; 726/17

(57) ABSTRACT

A method of processing a document that includes automatically processing the document in accordance with a user selection, converting a copy of the document into an electronically searchable format, and storing the converted document and the associated metadata. A group of converted documents may then be queried for converted documents containing content or metadata matching a criteria.

### CROSS REFERENCE TO RELATED APPLICATIONS

This application claims priority to U.S. provisional patent application No. 61/513,064 titled, “Systems and Methods for Monitoring Document Transmission,” which was filed on Jul. 29, 2011.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates to document processing and, more particularly, to the tracking and monitoring of processed documents.

2. Description of the Related Art

Organizations, whether private or public, generate, collect and share a multitude of documents containing data and information relevant to their business operations every day, and often many of such documents contain information that is proprietary and confidential in nature. In many cases, confidentiality is vital to the success of the organization. For example, preserving the confidentiality of certain governmental documents is critical to national security, and preserving the confidentiality of corporate documents is key to maintaining trade secrets. Thus, the unauthorized disclosure of confidential documents may result in unwanted and unwelcome effects.

One device that has the potential to be used as an instrumentality in the unauthorized disclosure of information in hard copy or electronic form is a multi-function printing device. In some instances, paper documents that are scanned, printed or copied may be distributed by various means, such as electronically or in-person delivery, without proper authorization. In other instances, multi-function printing devices having electronic mail or facsimile capability may be used to share or transfer electronic documents without proper authorization.

An organization employing commercially available software may be able to track the transaction data related to documents flowing through a multi-function printing device. Such transaction data may include the type of transaction performed (e.g., fax, scan, print, copy, etc.) and the transaction volume (e.g., number of pages processed, number or jobs submitted by a particular user, etc.). However, such known tracking solutions do not have the ability to audit the transactions or see the actual content involved in those transactions. Accordingly, there is a need for an improved tracking and monitoring solution that provides insight into the actual content and data involved in each multi-function printing device transaction.

### SUMMARY

A system capable of and methods of processing a plurality of documents are disclosed. One example method of processing a plurality of documents at an imaging device may include receiving each of the plurality of documents and a user selected function associated with each of the plurality of documents, automatically determining the metadata associated with each of the plurality of documents, transmitting a copy of each of the plurality of documents and the associated metadata to a storage, and performing the user selected function on each of the plurality of received documents.

In one aspect, the imaging device may convert the copy of each of the plurality of documents to an electronically searchable format prior to transmitting each copy of the plurality of documents to the storage. In another aspect of one example method, converting the copy of each of the plurality of documents may occur in a computer.

In one aspect, the converting may include performing optical mark recognition on each of copy of the plurality of documents. In another aspect, the converting may include performing optical character recognition on each copy of the plurality of documents.

A second example method of processing a plurality of documents may include receiving, from an imaging device, an electronic copy of each of the plurality of documents and metadata associated with each of the plurality of documents, converting each of the plurality of documents into an electronically searchable format, automatically storing the converted documents and the associated metadata; and associating a storage location identifier with the stored converted documents and the associated metadata. This second example method may further include the performance of a user selected function on a first copy of each of the plurality of documents.

In one aspect of the second example method, the stored converted documents may be queried for the converted documents which match a criteria. In another aspect of the second example method, the associated metadata may be searched for converted documents that match a criteria.

A third example method of processing a document includes automatically processing the document in accordance with a user selection, converting a copy of the document into an electronically searchable format, and storing the converted document and the associated metadata. A group of converted documents may then be queried for converted documents containing content or metadata matching a criteria.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is one example embodiment of a system including an imaging device, a network, a computer and a data storage.

FIG. 2 is an example flowchart of one example method for processing documents using the example system of FIG. 1.

FIG. 3 is an example flowchart of one example method for storing a plurality of documents in the example system of FIG. 1.

### DETAILED DESCRIPTION OF THE DRAWINGS

The following description and drawings illustrate embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some example embodiments may be included in or substituted for those of others. The scope of the present application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity but rather denote the presence of at least one of the referenced item.

It will be further understood that each block of the example flowcharts or diagrams, and combinations of blocks in the example flowcharts or diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the description below.

These computer program instructions may also be stored in a non-transitory computer-readable memory that may direct a computer or other programmable data processing apparatus to function in a particular manner, such that the instructions stored in the computer-readable memory produce an article of manufacture, including an instruction means that implements the function specified in the block or blocks. The computer program instructions may also be loaded onto a computer or other programmable data processing apparatus to cause a series of operational actions or steps to be performed on the computer or other programmable apparatus to produce a computer implemented process such that the instructions that execute on the computer or other programmable apparatus implement the functions specified in the block or blocks.

Accordingly, blocks of the example flowcharts and diagrams support combinations of means for performing the specified functions, combinations of actions or steps for performing the specified functions and program instruction means for performing the specified functions. It will also be understood that each block of the diagrams, and combinations of blocks in the diagrams, may be implemented by special purpose hardware-based computer systems or combinations of special purpose hardware and computer instructions that perform the specified functions, actions or steps.

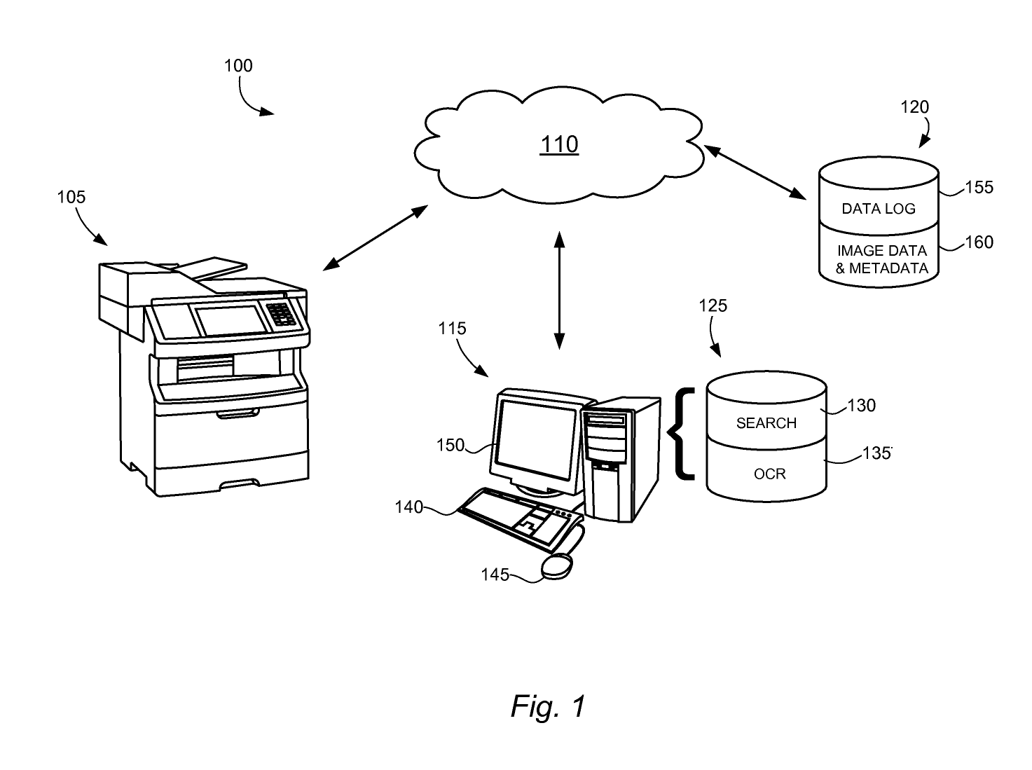

Disclosed are systems and methods for monitoring, tracking and managing data corresponding to documents processed by an imaging device. With reference to FIG. 1, there is shown one example system 100 including an imaging device 105, a network 110, a computer 115 and a data storage 120. Imaging device 105 may be connected to computer 115 in network 110 via a router (not shown) or via a host (not shown). Imaging device 105 may also communicate with data storage 120 via computer 115. In other example embodiments, imaging device 105 may be web-enabled and may communicate with computer 115 and/or data storage 120 via a direct connection to network 110. In yet other example embodiments, imaging device 105 may be locally connected to computer 115 and/or data storage 120 in a non-networked manner.

Imaging device 105 may be any device capable of printing or producing an electronic or a hard copy of a data file or document, such as a laser, inkjet or dot matrix printer. In some example embodiments, imaging device 105 may be a multi-function printing device that has the capability of performing additional functions, such a faxing, e-mailing, scanning and/or copying, in addition to printing.

Imaging device 105 may include various components, such as a processor, a network communications interface, user interface, a memory, a control unit and a print engine. Multi-function printing devices may have additional components, such as a scanning subsystem, modem, keyboard and/or other user input device. The control unit of imaging device 105 may include an embedded solution or application having the capability to capture the image data of documents processed by imaging device 105 and the metadata associated with the documents or the processing transaction. In some example embodiments, the embedded solution may be a software module or application that may be stored in a non-transitory computer readable storage medium associated with the control unit and executed by the control unit in accordance with programmed logic associated with the software application or module. In some alternate example embodiments, the embedded solution or application having the capability to capture the image data of documents processed by imaging device 105 and the metadata associated with the documents or the processing transaction may reside on a device separate from imaging device 105 but communicatively coupled to imaging device 105.

Metadata refers to data or information that describes and/or provides information related to the documents processed on imaging device 105. Metadata may include user identification information, device information and/or document processing information. In some example embodiments, user identification information may include the name or identifier of the user requesting the document processing. User identification information may also include a department or user group to which the user belongs. Device information may include an imaging device identifier, such as an Internet Protocol (IP) address, a Media Access Control (MAC) address, a network name and/or a network gateway associated with imaging device 105. Document processing information may include details of the document processing transaction performed by imaging device 105 on the documents, such as the type of action or transaction carried out or performed by imaging device 10; details associated with the action or transaction type; and/or the date and/or time of the document processing transaction. The transaction type may include, but is not limited to, printing, copying, scanning, faxing and e-mailing.

Processing or transaction type details may vary depending upon the transaction type. For example, transaction type details associated with a printing transaction may include the number of pages printed, the number of copies printed and/or finishing options, such as duplex or simplex printing, stapling, collating and n-up printing. Transaction type details associated with a copy transaction may include, but are not limited to, the number of pages copied, the number of copies made, and/or finishing options associated with the copies. Transaction type details associated with a scanning transaction may include, but are not limited to, the number of scanned pages and/or scanning destination, such as the drive or folder location. Transaction type details associated with a facsimile transaction may include, but are not limited to, the number of pages faxed, facsimile destination number and/or identifier associated with the facsimile destination number. Transaction type details associated with an electronic mail transaction may include, but are not limited to, the number of pages e-mailed, the subject line contents of the e-mail and/or e-mail address destination.

In some example embodiments, the user interface of imaging device 105 may be a graphical user interface, a monitor, a series of buttons, a touch-sensitive display panel, a voice-activated interface, a speaker or the like. In yet other example embodiments, the user interface may also serve as an input device for imaging device 10.

Imaging device 105 may be connected to network 110 via one or more appropriate communications links (not shown), as will be understood by those of ordinary skill in the art. For example, the one or more communications links may be established by a direct cable or optical connection, by a wireless connection, and/or by a network connection such as, for example, an Ethernet local area network (LAN) or wide area network (WAN).

Program or software modules or applications used in the operation of imaging device 105, or portions thereof, may be stored on local or remote memory storage devices and may be communicatively linked to various processing devices for performing certain tasks.

With continued reference to FIG. 1, network 110 may be any communications network such as, but not limited to, a peer-to-peer network, a hybrid peer-to-peer network, a LAN, a WAN or cellular network. Network 110 may be a public network, such as the Internet or a private network. Imaging device 105 may operate in a networked environment using logical connections to one or more other computing configurations, such as computer 115. Computer 115 may be a personal computer, a server, a router, a network PC, a peer device or other common network node.

In the example embodiment shown in FIG. 1, computer 115 may include at least one computer-readable storage medium 125 having stored thereon a search module or application 130 and an optical character recognition (OCR) application 135. In some other example embodiments, computer 115 may include an optical mark recognition (OMR) application in addition to or in lieu of an OCR application 135. Computer 115 may also include one or more user input devices, such as a keyboard 140 or mouse 145 and a display monitor 150. In some alternate example embodiments, display monitor 115 may include functionality of user input devices 140, 145, such as in a touch screen display, thereby eliminating the need for separate user input devices for computer 115.

Computer 115 may be connected to data storage 120 over network 110 via one or more communications links. In some example embodiments, data storage 120 may be accessed via a web-based function or via a cloud computing communication link. Data storage 120 may be a data storage device, a designated server system or computing system, or a designated portion of one or more server systems or computing systems. In another example embodiment, data storage 120 may be a security system provider computing system, a distributed database or an external and/or portable hard drive. In still other example embodiments, data storage 120 may be a dedicated mass storage device implemented in software, hardware, or a combination of hardware and software. Data storage 120 may store image data and/or document files and/or metadata.

In some alternate example embodiments, data storage 120 may be a data storage or mass storage device located in remote computer 115. Additionally, although example system 100 of FIG. 1 shows only one imaging device 105, one computer 115 and one data storage 120, those of ordinary skill in the art will appreciate that example system 100 may have additional components and/or multiples of the components enumerated in this disclosure.

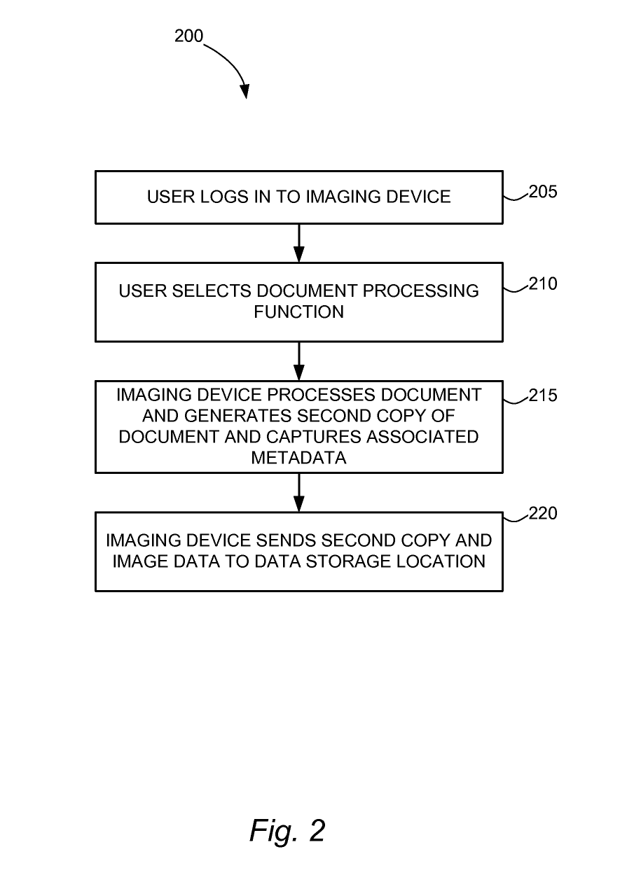

FIG. 2 is an example flowchart 200 of one example method for processing documents at imaging device 105.

Imaging device 105 may require a user to log in to imaging device 10 and provide user authentication details before allowing the user to access functions available in imaging device 105. At block 205, a user of imaging device 105 may access imaging device 105 by logging in to imaging device 105. Logging in may include providing authentication details to imaging device 105 through the use of a common access card (CAC), identification card, secure card or any other smart card. Such cards may contain user information that may be used to authenticate, confirm or verify the identity of the user. For example, the user may log in to imaging device 105 swiping an appropriate smart card containing authentication or user information at a card reader communicatively coupled to imaging device 105. In other example embodiments, the log in process may include imaging device 105 prompting the user for authentication or security credentials prior to allowing the user access to imaging device 105. For example, the user may be prompted to enter authentication information, such as a username and password, via the user input device of imaging device 105. It will be understood by one of ordinary skill in the art that the smart card may contain other information about the user, such as a user identifier and/or his personal preferences, such as duplex printing, which may be automatically provided or transmitted to imaging device 105 upon authentication of the user.

At block 210, once the identity of user is verified and the user's authentication details confirm that the user is authorized to access imaging device 10, the user may select a function available in imaging device 105 to process the desired document. Available process functions may include the printing, e-mailing, scanning, faxing or copying of the desired document. For example, upon logging in to imaging device 105, the user may elect or choose to e-mail a copy of the one or more documents to a particular e-mail address provided by the user through the smart card or input devices of imaging device 105.

The document on which the selected function is to be performed pre-exists in either hard copy or electronic form. The document may be associated with a particular project or belong within a particular category or group of document types. For example, the document may be part of a project named “Project Alpha” and may be highly sensitive internal memorandum within an organization.

In some alternate example embodiments, the user may select the desired document processing function prior to entering his credentials on imaging device 105. In some example embodiments, the authentication process may include verifying or confirming that the user is authorized to access the desired document processing function in addition to verifying the user is authorized to use imaging device 105.

At block 215, imaging device 105 may process the document according to the function selected by the user by automatically generating or creating the image data necessary to complete the desired function on the document. Image data of the document may refer to the document in an image format, such as .tiff, .gif, .jpeg or .bmp. In some aspects of one example embodiment, image data may refer to another document or file format, such as .pdf.

Generating may include making a first copy or instance of the document and performing the desired function on such copy or instance. Imaging device 105 may also automatically generate or create a second copy or instance of the image data of the document in electronic form. Such second copy or instance may be sent to computer 115, as will be explained in greater detail below. For example, when a user of imaging device 105 prints a document, imaging device 105 may render the document into a printable format and produce a printed output from the rendered document.

At block 215, a solution running on imaging device 105 may also capture metadata associated with the document processing transaction and/or the document itself. For example, when the user initiates an e-mail transaction of a document to a specified e-mail address, imaging device 105 may process the document by electronically sending a first copy of the document to the specified e-mail address and generating a second instance of the document, as well as collect metadata associated with the document processing transaction. As described earlier, metadata for an e-mail transaction may include information identifying the user who initiated the e-mailing of the document, the name or identifier of imaging device 105, the time the e-mail was sent, and the e-mail address to which the document was sent.

In some alternate example embodiments, imaging device 105 may only generate or create a second copy of the image data and capture the corresponding metadata for a subset of documents processed by imaging device 105. For example, the second copies of documents and their corresponding metadata may only be generated and captured for documents meeting a specific criteria or condition such as, for example, a particular project, time period, user group, document type or transaction type.

At block 220, imaging device 105 may automatically send the second copy of the document and the captured metadata associated with the processed document to computer 115 via one or more communication links. In some other example embodiments, the user of imaging device 105 may be prompted for permission to allow the transmission of the second copies and their associated metadata to computer 105 prior to their actual transmission.

The user of imaging device 105 may or may not be informed or notified that a second copy of the document and the captured metadata associated with the processed document are being sent to computer 115. In one aspect of some example embodiments, imaging device 105 may inform the user that image data corresponding to the documents processed by imaging device 105 have been sent to computer 115 via a notification displayed on a graphical user interface of imaging device 105. In another aspect of some example embodiments, the notification may be provided as a printed output in addition to or in lieu of the displayed notification.

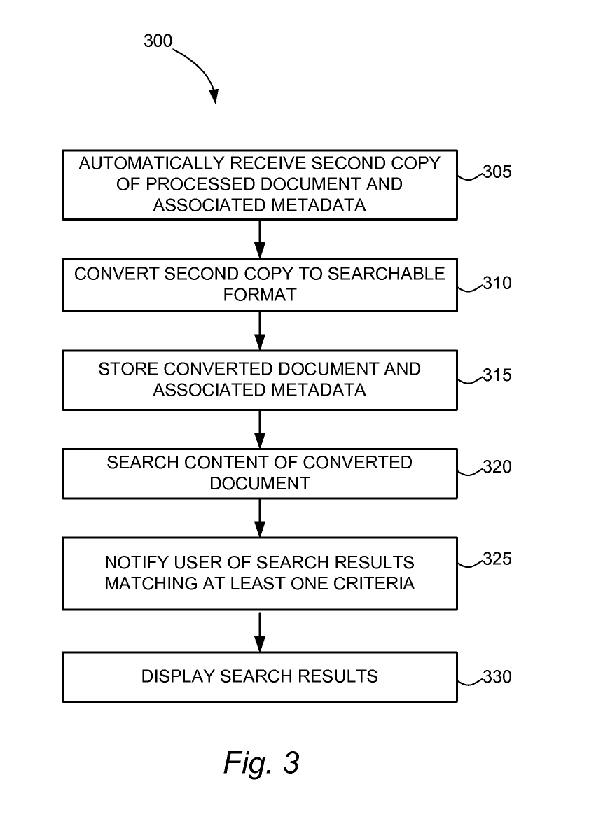

FIG. 3 is an example flowchart 300 of one example method for storing a plurality of documents. At block 305, computer 115 may automatically receive the second copy of each document processed by imaging device 105 and its corresponding metadata via a communications link, as will be understood by those of ordinary skill in the art. In some example embodiments, computer 115 may automatically receive the second copy of a subset of documents processed by imaging device 105 and their corresponding metadata. For example, the second copies of documents and their corresponding metadata may only be received for documents meeting a specific criteria or condition, such as, for example, a particular project, time period, user group, document type or transaction type.

In some alternate example embodiments, a user of computer 115 may be prompted for permission to accept the transmission of the second copies of the documents processed by imaging device 105 and their corresponding metadata prior to their transmission to computer 115.

At block 310, computer 115 may convert the second copy of the documents received from imaging device 105 to a searchable format. In some example embodiments, converting the second copy of the documents into an electronically searchable format may include performing optical character recognition (OCR) on the documents. In other example embodiments, converting the second copy of the documents may include performing optical mark recognition (OMR) in addition to or in lieu of the performance of OCR. It will be understood that other methods of converting image data into a searchable format other than OCR and OMR may be performed on the second copy of the documents.

In some alternate example embodiments, imaging device 105 may convert the second copy of the processed documents into a searchable data format prior to transmitting the image data of the second copies and their corresponding metadata to computer 115.

At block 315, after converting the image data received from imaging device 105, computer 115 may automatically send or transmit via one or more communication links each of the converted documents and their associated metadata to data storage 120 for storing. In some example embodiments, an index to list of the converted documents and their associated metadata may be stored in a data log portion 155 of data storage 120, and the converted documents and metadata may be stored in a data content portion 160 of data storage 120. In one alternate example embodiment, the transmission of the converted image data and their associated metadata may be initiated by a user of computer 115.

At block 320, a user of computer 115 may search the content of the converted documents and/or their associated metadata for at least one criteria. Criteria may be any keyword, image, marking or other identifier that may be used to locate or identify documents of interest. In one aspect of some example embodiments, the criteria may be set by a user of computer 115 and the search conducted in real time. For example, a user may log in to computer 115 and conduct a full-text search on the converted documents and/or their associated metadata for documents containing the phrase, “Project Alpha” and/or a user “John Smith.” As another example, a user may set the criteria to an image, such as a logo of “Project Alpha” and conduct an image search on the converted documents and/or their associated metadata for documents containing such image.

In some other example embodiments, the criteria to be used for searching may be preset or predetermined by a system administrator or manager and the search conducted on a scheduled and/or repeating basis.

In some alternate example embodiments, remote computer 115 may automatically and continuously monitor the converted documents for at least one document containing data matching at least one of the criteria prior to sending or transmitting the converted documents and their associated metadata to data storage 120 for storing.

In addition to identifying the documents matching the search criteria, the search results may also include other information corresponding to the matching documents and/or metadata. Such other information may include, but is not limited to, the user of imaging device 105 who initiated the processing of the matching documents, the details of the document processing transaction, such as the date and/or time the documents were processed and/or the device identifier of the imaging device 105 used to process the documents.

Searching the content of the converted documents and/or metadata may allow a user of computer 115 to monitor or audit users of imaging device 105 and/or the documents processed using imaging device 105 and be helpful in determining whether any security breaches and/or unauthorized document processing functions occurred and if so, identifying who was involved in such unauthorized transactions.

At block 325, computer 115 may notify a user of the search results. Such notification may include an indication of whether or not at least one document containing data that matches the criteria has been identified. The notification may include a visual notification displayed on user interface 150 of computer 105 or any client computer used by the user to access the converted documents. In some example embodiments, the notification may include an audio signal in addition to or in lieu of a visual notification. In some other example embodiments, the notification may be the automatic transmission of an e-mail alert to a pre-designated e-mail address. In still other example embodiments, the notification may be facsimile sent to a pre-designated phone number.

At block 330, computer 115 may provide the search results as a listing of the documents matching the criteria and/or the copies of the documents in addition to or in lieu of the notification of whether at least match has been detected. The search results may be displayed user interface 150 of computer 115 or any client device used to access computer 115 or data storage location 120.

In some example embodiments, providing the search results may include generating or creating a report containing the search results. The generated report may include a list the documents that match the criteria searched. The generated report may also contain information regarding the matching documents, such as the user identifier of the user of imaging device 105 who initiated the processing of the matching documents and/or some or all of the metadata associated with the matching documents. In some example embodiments, the generated report may be sent to imaging device 105 for printing. In other example embodiments, the generated report may be electronically transmitted in lieu of or in addition to being displayed and/or printed. Electronically transmitting the report may include e-mailing the report or sending a fax copy of the report to a designated recipient.

While the above example embodiments are shown as printing environments, other embodiments of the present disclosure may be implemented outside the scope of a printing environment. Other example embodiments may include other devices and networks such as security systems, data collection and data distribution systems. One example device may be a computing device that processes one or more documents and whose activity may be audited by user, device, transaction type, full-text of the documents, and/or location information.

It will be appreciated that the actions described and shown in the example flowcharts may be carried out or performed in any suitable order. It will also be appreciated that not all of the actions described in FIGS. 2 and 3 needs to be performed in accordance with the example embodiments of the disclosure and/or additional actions may be performed in accordance with other embodiments of the disclosure.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific example embodiments disclosed and that modifications and other embodiments are intended to be included within the scope of the appended claims. Although specific terms are employed herein, they are used in a generic and descriptive sense only and not for purposes of limitation.

What is claimed is:

1. A method of processing a plurality of documents at an imaging device, comprising:
receiving each of the plurality of documents and a user selected function associated with each of the plurality of documents;
automatically determining the metadata associated with each of the plurality of documents;
transmitting a copy of each of the plurality of documents and the associated metadata to a storage; and
performing the user selected function on each of the plurality of received documents.

2. The method of claim 1, further comprising converting the copy of each of the plurality of documents to an electronically searchable format prior to the transmitting.

3. The method of claim 2, further comprising automatically transmitting the converted copy of each of the plurality of documents and the associated metadata to the storage.

4. The method of claim 2, wherein the converting the copy of each of the plurality of documents includes performing optical mark recognition on each copy of the plurality of documents.

5. The method of claim 2, wherein the converting the copy of each of the plurality of documents includes performing optical character recognition on each copy of the plurality of documents.

6. The method of claim 1, wherein the associated metadata comprises at least one of a user identifier, an imaging device identifier and a time associated with the performing of the user selected function.

7. The method of claim 1, further comprising receiving an authentication information from a user.

8. The method of claim 2, further comprising automatically searching the converted copy of each of the plurality of documents for data matching at least one criteria.

9. A method of processing a plurality of documents, comprising:
receiving, from an imaging device, an electronic copy of each of the plurality of documents and metadata associated with each of the plurality of documents;
converting each of the plurality of documents into an electronically searchable format;
automatically storing the converted documents and the associated metadata; and
associating a storage location identifier with the stored converted documents and the associated metadata,
wherein a user selected function is performed on a first copy of each of the plurality of documents.

10. The method of claim 9, wherein the automatically storing comprises:
storing the converted documents in a database; and
logging the associated metadata in a data log.

11. The method of claim 9, wherein the automatically storing comprises transmitting the converted documents and the associated metadata to a remote storage.

12. The method of claim 9, further comprising querying the converted documents for converted documents which match a criteria.

13. The method of claim 9, further comprising querying the associated metadata for converted documents which match a criteria.

14. The method of claim 9, further comprising automatically querying the converted documents for converted documents which match a criteria.

15. The method of claim 9, further comprising identifying the converted documents which match a criteria.

16. The method of claim 9, further comprising retrieving the converted documents which match a criteria.

17. The method of claim 9, further comprising generating a report containing the storage location identifier and the associated metadata of the converted documents which match a criteria.

18. The method of claim 9, further comprising displaying on a user interface a report containing the storage location identifier and the associated metadata of the converted documents which match a criteria.

19. A method of processing a document, comprising:
verifying a user's access to a device is authorized; and
if the user's access to the device is authorized, automatically
processing the document in accordance with a user selection;
converting a copy of the document into an electronically searchable format; and
sending the converted copy of the document and metadata associated with the document to a database.

20. The method of claim 19, wherein the converted document may be retrieved by a query in which at least one of content of the converted document and the associated metadata matches a criteria used in the query.
